(19) United States
(12) Patent Application Publication
(10) Pub. No.: US 2002/0159750 A1
(43) Pub. Date: Oct. 31, 2002

(54) Method for segmenting and indexing TV programs using multi-media cues

(75) Inventors: Radu S. Jasinschi, Ossining, NY (US); Jennifer Louie, Oradell, NJ (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/843,499

(22) Filed: Apr. 26, 2001

(51) Int. Cl. H04N 5/91

(52) U.S. Cl. 386/46; 386/83

(57) ABSTRACT

The present invention is directed to a method of segmenting and indexing video using multi-media cues characteristic of a given genre of program. According to the present invention, these multi-media cues are selected by a multi-media information probability being calculated for each frame of video segments. Each of the video segments is divided into sub-segments. A probability distribution of multi-media information is also calculated for each of the sub-segments using the multi-media information for each frame. The probability distribution for each sub-segments are combined to form a combined probability distribution. Further, the multi-media information having the highest combined probability in the combined probability distribution is selected as the dominant multi-media cues.

### BACKGROUND OF THE INVENTION

The present invention generally relates to video data services and devices, and more particularly to a method and device for segmenting and indexing TV programs using multi-media cues.

On the market today, there are a number of video data services and devices. An example of one is the TIVO box. This device is a personal digital video recorder capable of continuously recording satellite, cable or broadcast TV. The TIVO box also includes an electronic program guide (EPG) that enables a user to select a particular program or category of program to be recorded.

One way TV programs are classified is according to Genre. Genre describes TV programs by categories such as business, documentary, drama, health, news, sports and talk. An example of genre classification is found in the Tribune Media Services EPG. In this particular EPG, Fields 173 to 178, designated “tf_genre_desc”, are reserved for textual description of TV program genre. Therefore, using these fields, a user can program a TIVO-type box to record programs of a particular type genre.

However, the use of EPG-based descriptions may not always be desirable. First of all, EPG data may not always be available or always accurate. Further, the genre classification in current EPGs is for a whole program. However, it is possible that the genre classification in a single program may change from segment to segment. Therefore, it is would be desirable to generate genre classifications directly from the program independent (1Y) of the EPG data.

### SUMMARY OF THE INVENTION

The present invention is directed to a method of selecting dominant multi-media cues from a number of video segments. The method includes a multi-media information probability being calculated for each frame of the video segments. Each of the video segments is divided into sub-segments. A probability distribution of multi-media information is also calculated for each of the sub-segments using the multi-media information for each frame. The probability distribution for each sub-segment is combined to form a combined probability distribution. Further, the multi-media information having the highest combined probability in the combined probability distribution is selected as the dominant multi-media cues.

The present invention is also directed to a method of segmenting and indexing video. The method includes program segments that are selected from the video. The program segments are divided into program sub-segments. Genre-based indexing is performed on the program sub-segments using multi-media cues characteristic of a given genre of program. Further, object-based indexing is also performed on the program sub-segments.

The present invention is also directed to a method of storing video. The method includes the video being pre-processed. Also, program segments are selected from the video. The program segments are divided into program sub-segments. Genre-based indexing is performed on the program sub-segments using multi-media cues characteristic of a given genre of program. Further, object-based indexing is also performed on the program sub-segments.

The present invention is also directed to a device for storing video. The device includes a pre-processor for pre-processing the video. A segmenting and indexing unit is included for selecting program segments from the video, dividing the program segments into program sub-segments and performing genre-based indexing on the program sub-segments using multi-media cues characteristic of a given genre of program to produce indexed program sub-segments. A storage device is also included for storing the indexed program sub-segments. Further, the segmenting and indexing unit also performs object-based indexing on the program sub-segments.

### BRIEF DESCRIPTION OF THE DRAWINGS

Referring now to the drawings were like reference numbers represent corresponding parts throughout:

FIG. 1 is a flow chart showing one example of a method for determining the multi-media cues according to the present invention;

FIG. 2 is a table showing one example of probabilities for mid-level audio information;

FIG. 3 is a table showing one example of a system of votes and thresholds according to the present invention;

FIG. 4 is a bar graph showing a probability distribution calculated using the system of FIG. 3;

FIG. 5 is a flow chart showing one example of a method for segmenting and indexing TV programs according to the present invention;

FIG. 6 is a bar graph illustrating another example of multi-media cues according to the present invention;

FIG. 7 is a block diagram showing one example of a video recording device according to the present invention.

### DETAILED DESCRIPTION

Multi-media information is divided into three domains including (i) audio, (ii) visual, and (iii) textual. This information within each domain is divided in different levels of granularity including low, mid, and high-level. For example, low-level audio information is described by signal processing parameters, such as, average signal energy, cepstral coefficients, and pitch. An example of low-level visual information is pixel or frame-based including visual attributes, such as, color, motion, shape, and texture that are represented at each pixel. For closed captioning (CC), low-level information is given by ASCII characters, such as, letters or words.

According to the present invention, it is preferable to use mid-level multimedia information. Such mid-level audio information usually is made up of the silence, noise, speech, music, speech plus noise, speech plus speech, and speech plus music categories. For the mid-level visual information key-frames are used, which are defined as the first frame of a new video shot (sequence of video frames with similar intensity profile), color, and visual text (text superimposed on video images). For mid-level CC information, a set of keywords (words representative of textual information), and categories such as weather, international, crime, sports, movies, fashion, tech stocks, music, automobiles, war, economy, energy, disasters, art and politics.

As mid-level information of the three multimedia domains probabilities are used. These probabilities are real numbers between zero and one, which determine how representative each category is, for each domain, within a given video segment. For example, numbers close to one determine that a given category is highly probable to be part of a video sequence, while numbers close to zero determine that the corresponding category is less likely to occurs in a video sequence. It should be noted that the present invention is not restricted to the particular choices of mid-level information described above.

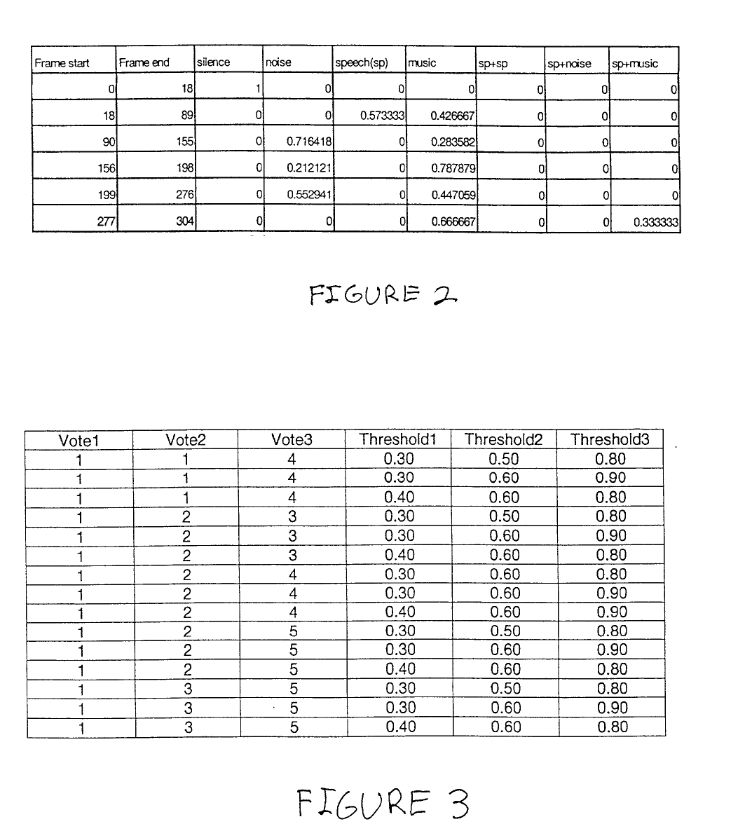

According to the present invention, it has been found that for a particular type of program, there are dominant multi-media characteristics or cues. For example, there is usually a higher percentage of key-frames per unit time in commercials than in program segments. Further, there is also a usual higher amount of speech in talk shows. Thus, according to the present invention, these multi-media cues are used to segment and index TV programs, as described below in conjunction with FIG. 2. In particular, these multi-media cues are used to generate genre classification information for TV program sub-segments. In contrast, current personal video recorders such as the TIVO box only include genre classification for a whole program as brief descriptive textual information in the EPG. Further, according to the present invention, the multi-media cues are also used to separate program segments from commercial segments.

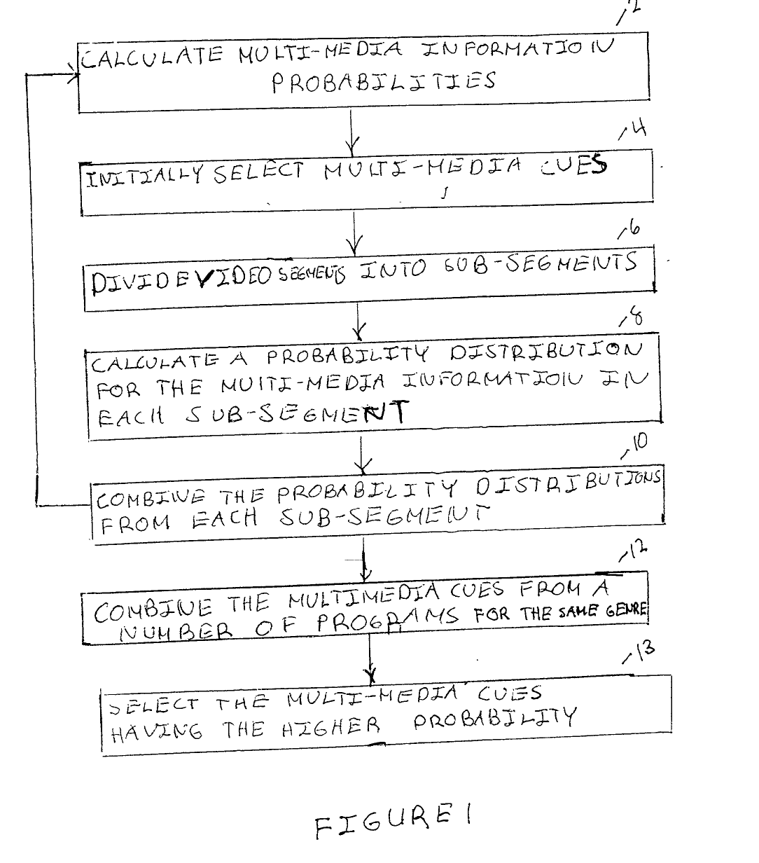

Before being used, the multi-media cues are first determined. One example of a method for determining the multi-media cues according to the present invention is shown in FIG. 1. In the method of FIG. 1, discrete video segments for each program are processed in steps 2-10. Further, in steps 12-13, a number of programs are processed in order to determine the multi-media cues for a particular genre. For the purpose of this discussion, it is presumed that the video segments may originate from cable, satellite or broadcast TV programming. Since these types of programming all include both program segments and commercial segments, it is further presumed that a video segment may be either a program segment or a commercial segment.

In step 2, multi-media information probability for each frame of the video is calculated. This includes calculating the probability of occurrence of multi-media information such as audio, video and transcript in each frame of video. In order to perform step 2, different techniques are utilized depending on the category of multimedia information.

In the visual domain such as for keyframes, macroblock level information from the DC component of the DCT coefficients to determine frame differences is utilized. The probability of a keyframe occurrence is a normalized number, between zero and one, of a given DC component difference being larger than a (experimentally) given threshold. Given two consecutive frames, the DC components are extracted. This difference is compared to a threshold that is determined experimentally. Also, a maximum value for the DC difference is computed. The range between this maximum value and zero (the DC difference is equal to the threshold) is used to generate the probability, that is equal to the (DC_difference—threshold)/max_DC_difference.

For video text, the probability is calculated by the sequential use of edge detection, thresholding, region merging, and character shape extraction. In the current implementation, the presence or absence of text characters per frame is only looked at. Therefore, for the presence of text characters the probability is equal to one and for the absence of text characters the probability is equal to zero. Further, for faces, the probability is calculated by detecting with a given probability that depends on the joint of face skin tone color and oval face shape.

In the audio domain, for each twenty-two (22) ms temporal window “a segment” classification is realized between silence, noise, speech, music, speech plus noise, speech plus speech, and speech plus music categories. This is a “winner take all” decision where only one category wins. Then this is repeated for a hundred (100) such consecutive segments, that are, about two (2) seconds in duration. Then, a count (or vote) for the number of segments with a given category classification is performed, which is then divided by a hundred (100). This gives the probability for each category for all of the two (2) second intervals.

In the transcript domain, there are 20 close captioning (CC) categories including weather, international, crime, sports, movies, fashion, tech stocks, music, automobiles, war, economy, energy, stocks, violence, financial, national, biotech, disasters, art, and politics. Each category is associated with a set of “master” keywords. There exists overlap in this set of keywords. For each CC paragraph, between the “>>” symbol, keywords are determined, such as, words that repeat, and match these to the 20 lists of “master” keywords. If there is a match between the two, a vote is given to that key word. This is repeated for all keywords in the paragraph. In the end, these votes are divided by the total number of occurrences of this keyword within each paragraph. Therefore, this is the CC category probability.

For step 2, it is preferred that probabilities for each of the (mid-level) categories of the multi-media information within each domain are calculated, which is done for each frame of the video sequence. An example of such probabilities in the audio domain is shown in FIG. 2, which includes the seven audio categories as defined above. The first two columns of FIG. 2 correspond to the start and end frames of the video. While the last seven columns include the corresponding probabilities, one for each mid-level category.

Referring back to FIG. 1, in step 4, multi-media cues are initially selected that are characteristic of a given TV program type. However, at this time, this selection is based on common knowledge. For example, it is commonly known that TV commercials have, in general, a high cut rate (=a large number of shots or average key-frames per unit time); then use visual key-frame rate information. In another example, it is common for MTV programs, in the majority of cases, there will be a lot of music. Thus, the common knowledge says that audio cues should be used, and in particular focus on the “music” and (maybe) the “speech+music” categories. Therefore, common knowledge is the corpus of TV production cues and elements that are common (as verified by field tests) in TV programs.

In step 6, the video segments are divided into sub-segments. Step 6 may be performed in a number of different ways including dividing video segments into arbitrary equal sub-segments or by using a pre-computed tessellation. Further, the video segments may also be divided using close caption information if included in the transcript information of the video segments. As is commonly known, close caption information includes, in addition to the ASCII characters representing letters of an alphabet, characters, such as the double arrows to indicate a change in subject or person speaking. Since a change in speaker or subject could indicate a significant change in the video content information, it may be desirable to divide the video segments in such as way as to respect speaker change information. Therefore, in step 6, it may be preferable to divide the video segments at the occurrence of such characters.

In step 8, a probability distribution is calculated for the multi-media information included in each of the sub-segments using the probabilities calculated in step 2. This is necessary since the probabilities calculated are for each frame and there are many frames in the video of TV programs typically about 30 frames per second. Thus, by determining probability distributions per sub-segments, an appreciable compactness is obtained. In step 8, the probability distribution is obtained by first comparing each probability with a (pre-determined) threshold for each category of multimedia information. In order to allow the maximum amount of frames to pass through, a lower threshold is preferred such as, 0.1. If each probability is larger than its corresponding threshold, then a one (1) is associated to that category. If each probability is not larger, a zero (0) is assigned. Further, after assigning the 0s and 1s to each category, these values are summed and divided by the total number of frames per video sub-segment. This results in a number determining the number of times that a given category is present conditioned on a set of thresholds.

In step 10, the probability distributions calculated for each sub-segment in step 8 are combined to provide a single probability distribution for all of the video segments in a particular program. According to the present invention, step 10 may be performed by either forming an average or a weighted average of the probability distributions of each of the sub-segments.

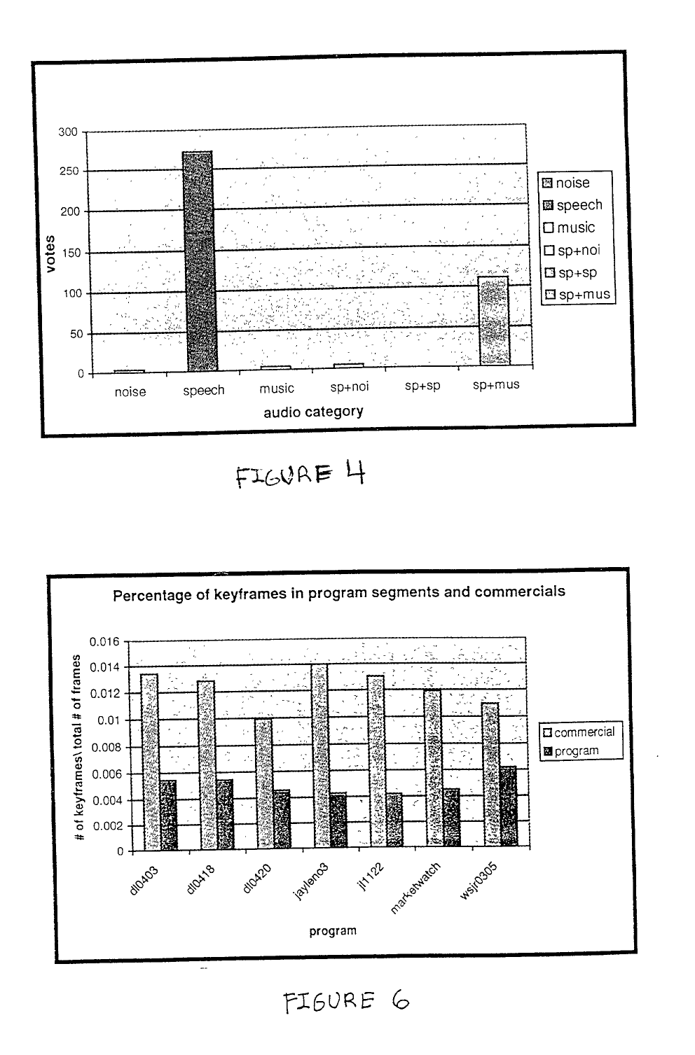

In order to calculate a weighted average for step 10, it is preferable that a system of votes and thresholds be used. An example of such a system is shown in FIG. 3, where the number of votes in the first three columns correspond to the thresholds in the last three columns. For example, in FIG. 3, it is assumed that, out of the seven audio categories, three (3) are dominant. This presumption is based on the multi-media cues initially selected in step 4 of FIG. 1. The probabilities for each sub-segment of the target video and for each of the seven audio categories are transformed to numbers from zero to 1, where 100% will correspond to a probability of 1.0, etc. First, it is determined in what range the sub-segment probability P falls. For example, in FIG. 3, four ranges are included for a given probability P. In line 1 these are: (i) (0≦P<0.3), (ii) (0.3≦P<0.5), (iii) (0.5≦P<0.8), (iv) (0.8≦P<1.0). The three thresholds determine the range bounds. Second, a vote depending on within what range P falls in and is then assigned. This process is repeated for all fifteen possible combinations shown in FIG. 3. At the end of this process, a given number of total votes per sub-segment is obtained. This process is common to any multimedia category. At the end of this process all the sub-segments of a given program segment (or commercial) and all program segments are processed to provide a probability distribution for the whole program.

Referring back to FIG. 1, after performing step 10, the method may loop back to step 2 in order to begin processing the video segments of another program. If only one program is being processed, then the method will just advance to step 13. However, it is preferred that a number of programs should be processed for a given genre of programs or commercials. If there are no more programs to be processed, the method will proceed to step 12.

In step 12, the probability distributions from a number of programs of the same genre are combined. This provides a probability distribution for all of the programs of the same genre. An example of such a probability distribution is shown in FIG. 4. According to the present invention, step 12 may be performed by either calculating an average or a weighted average of the probability distributions for all of the programs of the same genre. Also, if the probability distributions being combined in step 12 were calculated using a system of votes and thresholds, then step 12 may also be performed by simply summing the votes of the same category for all of the programs of same genre.

After performing step 12, the multi-media cues having the higher probabilities are selected in step 13. In the probability distributions calculated in step 12, a probability is associated with each category and for each multimedia cue. Thus, in step 13, categories having a higher probability will be selected as the dominant multi-media cues. However, a single category with the absolute largest probability value is not selected. Instead, a set of categories having the joint highest probability is selected. For example, in FIG. 4, the speech and speech plus music (SpMu) categories have the highest probability for TV NEWS program and thus would be selected as the dominant multimedia cues in step 13.

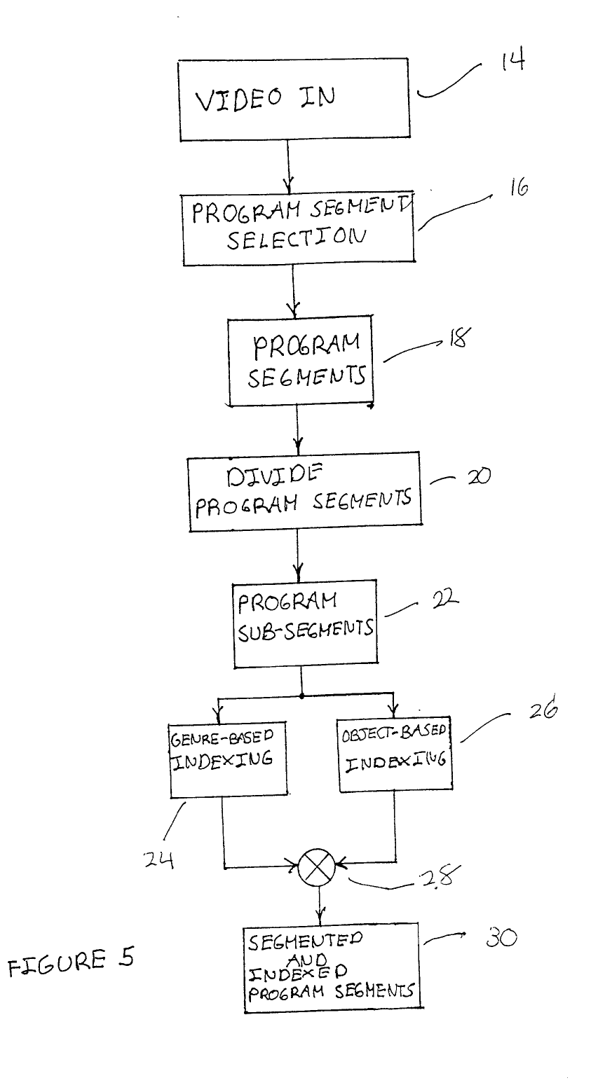

One example of a method for segmenting and indexing TV programs according to the present invention is shown in FIG. 5. As can be seen, the first box represents the video in 14 that will be segmented and indexed according to the present invention. For the purpose of this discussion, the video in 14 may represent cable, satellite or broadcast TV programming that includes a number of discrete program segments. Further, as in most TV programming, there are commercial segments in between the program segments.

In step 16, the program segments are selected from the video in 14 in order to separate the program segments 18 from the commercial segments. There exists a number of known methods for selecting the program segments in step 16. However, according to the present invention, it is preferred that the program segments are selected 16 using multi-media cues characteristic of a given type of video segment.

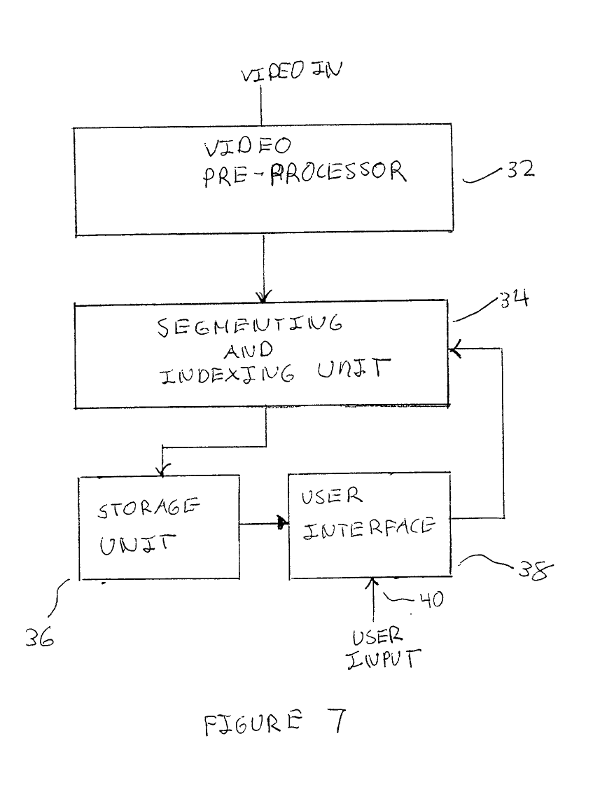

As previously described, multi-media cues are selected that are capable of identifying a commercial in a video stream. An example of one is shown in FIG. 6. As can be seen, the percentage of key-frames is much higher for commercials than programs. Thus, key frame rate would be a good example of a multi-media cue to be utilized in step 16. In step 16, these multi-media cues are compared to segments of the video in 14. The segments that do not fit the pattern of the multi-media cues are selected as the program segments 18. This is done by comparing the test video program/commercial segments' probabilities for each multimedia categories with the probabilities obtained above in the method of FIG. 1.

In step 20, the program segments are divided into sub-segments 22. This division may be done by dividing the program segments into arbitrary equal sub-segments or by using a pre-computed tessellation. However, it may be preferable to divide the program segments in step 20 according to close caption information that is included in the video segments. As previously described, close caption information includes characters (double arrows) to indicate a change in subject or person speaking. Since a change in speaker or subject could indicate a significant change in the video, this is a desirable place to divide the program segments 18. Therefore, in step 20, it may be preferable to divide the program segments at the occurrence of such a character.

After performing step 20, indexing is then performed on the program sub-segments 22 in steps 24 and 26, as shown. In step 24, genre-based indexing is performed on each of the program sub-segments 22. As previously described, genre describes TV programs by categories such as business, documentary, drama, health, news, sports and talk. Thus, in step 24, genre-based information is inserted in each of the sub-segments 22. This genre-based information could be in a form of a tag that corresponds to the genre classification of each of the sub-segments 22.

According to the present invention, the genre-based indexing 24 will be performed using the multi-media cues generated by the method described in FIG. 1. As previously described, these multi-media cues are characteristic of a given genre of program. Thus, in step 24, multi-media cues that are characteristic of a particular genre of program are compared to each of the sub-segments 22. Where there is a match between one of the multi-media cues and sub-segments, a tag indicating the genre is inserted.

In step 26, object-based indexing is performed on the program sub-segments 22. Thus, in step 26, information identifying each of the objects included in a sub-segment is inserted. This object-based information could be in a form of a tag that corresponds to each of the objects. For the purpose of this discussion an object may be background, foreground, people, cars, audio, faces, music clips, etc. There exists a number of known methods for performing the object-based indexing. Examples of such methods are described in U.S. Pat. No. 5,969,755, entitled “Motion Based Event Detection System and Method”, to Courtney, U.S. Pat. No. 5,606,655, entitled “Method For Representing Contents Of A Single Video Shot Using Frames ”, to Arman et al., in U.S. Pat. No. 6,185,363, entitled “Visual Indexing System”, to Dimitrova, et al. and in U.S. Pat. No. 6,182,069, entitled “Video Query System and Method”, to Niblack et al., which are all hereby incorporated by reference.

In step 28, the sub-segments after being indexed in steps 24,26 are combined to produce segmented and indexed program segments 30. In performing step 28, the genre-based information or tags and the object-based information or tags from corresponding sub-segments is compared. Where there is match between the two, the genre-based and object-based information is combined into the same sub-segment. As result of step 28, each of the segmented and indexed program segments 30 include tags indicating both genre and the object information.

According to the present invention, the segmented and indexed program segments 30 produced by the method of FIG. 1 may be utilized in a personal recording device. An example of such a video recording device is shown in FIG. 7. As can be seen, the video recording device includes a video pre-processor 32 that receives the Video In. During operation, the pre-processor 32 performs pre-processing on the Video In such as de-multiplexing or decoding, if necessary.

A segmenting and indexing unit 34 is coupled to the output of the video preprocessor 32. The segmenting and indexing unit 34 receives the Video In after being preprocessed to segment and index the Video according to the method of FIG. 5. As previously described, the method of FIG. 5 divides the Video In into program sub-segments and, then performs genre-based indexing and object based indexing on each of the sub-segments to produce the segmented and indexed program segments.

A storage unit 36 is coupled to the output of the segmenting and indexing unit 34. The storage unit 36 is utilized to store the Video In after being segmented and indexed. The storage unit 36 may be embodied by either a magnetic or an optical storage device. As can be further seen, a user interface 38 is also included. The user interface 38 is utilized to access the storage unit 36. According to the present invention, a user may utilize the genre-based and object-based information inserted into the segmented and indexed program segments, as previously described. This would enable a user via the user input 40 to retrieve a whole program, program segment or program sub-segment based on either a particular genre or object.

The foregoing description of the present invention has been presented for the purposes of illustration and description. It is not intended to limit the invention to the precise forms disclosed. Many modifications and variations are possible in light of the above teachings. Therefore, it is intended that the scope of the invention should not be limited by the detailed description.

What is claimed is:

1. A method for selecting dominant multi-media cues from a number of video segments, comprising the steps of:
calculating a multi-media information probability for each frame of the video segments;
dividing each of the video segments into sub-segments;
calculating a probability distribution of multi-media information for each of the sub-segments using the multi-media information for each frame;
combining the probability distribution for each sub-segments to form a combined probability distribution; and
selecting the multi-media information having the highest combined probability in the combined probability distribution as the dominant multi-media cues.

2. The method of claim 1, wherein the video segments are selected from a group consisting of commercial segments and program segments.

3. The method of claim 1, wherein the dividing video segments into sub-segments is performed using close caption information included in the video segments.

4. The method of claim 1, wherein the combining the probability distribution for each sub-segments is performed by the operation selected from a group consisting of an average or a weighted average.

5. The method of claim 1, wherein the combined probability distribution is formed from probability distributions of sub-segments of multiple programs.

6. The method of claim 1, which further includes initially selecting multi-media cues characteristic of a given TV program type or commercial.

7. A method of segmenting and indexing video, comprising the steps of:
selecting program segments from the video;
dividing the program segments into program sub-segments; and
performing genre-based indexing on the program sub-segments using multi-media cues characteristic of a given genre of program.

8. The method of claim 7, wherein the selecting program segments is performed using multi-media cues characteristic of a given type of video segment.

9. The method of claim 7, wherein the dividing the program segments into program sub-segments is performed according to closed caption information included in the program segments.

10. The method of claim 7, wherein the genre-based indexing includes:
comparing the multi-media cues characteristic of a given genre of program to each of the program sub-segments; and
inserting a tag into one of the program sub-segments if there is a match between one of the multi-media cues and sub-segments.

11. The method of claim 7, which further include performing object-based indexing on the program sub-segments.

12. A method of storing video, comprising the steps of:
pre-processing the video;
selecting program segments from the video;
dividing the program segments into program sub-segments;
performing genre-based indexing on the program sub-segments using multi-media cues characteristic of a given genre of program to produce indexed program sub-segments; and
storing the indexed program sub-segments.

13. The method of claim 12, wherein the genre-based indexing includes:
comparing the multi-media cues characteristic of a given genre of program to each of the program sub-segments; and
inserting a tag into one of the program sub-segments if there is a match between one of the multi-media cues and sub-segments.

14. The method of claim 12, which further include performing object-based indexing on the program sub-segments.

15. A device for storing video, comprising:
a pre-processor for pre-processing the video;
a segmenting and indexing unit for selecting program segments from the video,
dividing the program segments into program sub-segments and performing genre-based indexing on the program sub-segments using multi-media cues characteristic of a given genre of program to produce indexed program sub-segments; and
a storage device for storing the indexed program sub-segments.

16. The method of claim 15, wherein the genre-based indexing includes:
comparing the multi-media cues characteristic of a given genre of program to each of the program sub-segments; and
inserting a tag into one of the program sub-segments if there is a match between one of the multi-media cues and sub-segments.

17. The method of claim 15, wherein the segmenting and indexing unit further performs object-based indexing on the program sub-segments.
